(19) United States
(12) Patent Application Publication
(10) Pub. No.: US 2012/0092851 A1
(43) Pub. Date: Apr. 19, 2012

(54) LED arrangement with an improved light yield and process for operating LED arrangement with an improved light yield

(75) Inventor: Juergen CZANIERA, Bonndorf (DE)

(73) Assignee: ATMOS MEDIZIN TECHNIK GMBH & CO. KG, Lenzkirch (DE)

(21) Appl. No.: 13/274,822

(22) Filed: Oct. 17, 2011

(30) Foreign Application Priority Data
Oct. 18, 2010 (DE) 10 2010 048 561.6

(51) Int. Cl. F21V 9/16; F21V 13/04; F21V 7/00

(52) U.S. Cl. 362/84

(57) ABSTRACT

An LED arrangement (10, 20) has a luminescence-conversion layer (3, 23) which is positioned on an LED chip (2, 22) and onto which at least a portion of the light reflected by a reflector (6, 27) is guided in such a way that an image of the LED chip is mapped or copied onto the LED chip. A process for operating a LED arrangement is implemented by: producing light by means of a LED chip; reflecting a portion of the light produced by the LED chip; and coupling the light into an optical system which has an acceptance requirement, while only light that fulfills the acceptance requirement can be coupled into the optical system and the light is reflected onto a luminescence-conversion layer in such a way that an image of the LED chip is mapped onto the LED chip.

The invention relates to an LED arrangement according to the preamble of claim 1, as well as to a process for operating such a LED arrangement.

In recent years, LEDs have played an ever greater role as sources of light due to the fact that a continuous increase in their performance has been possible with respect to optical flow and optical density. This development has been simultaneously accompanied by the ever-growing power of LED chips. Up to the year 2000, the market was thoroughly dominated by square LED chips with an edge length of roughly 0.3 mm edge. These were first displaced by chips with an edge length of about 1 mm. Since about 2009, however, LEDs have emerged whose edge length ranges between 3 mm and 5 mm and which are competitive with discharge lamps, e.g., high-pressure xenon lamps, with respect to optical flow and density.

LEDs are Lambertian sources, where each surface element of the LED emits its light into the entire half-space in accordance with Lambert's cosine law. While this fact is desirable for large-area illumination—for example, in lighting a room—it always has a negative effect when the goal is to couple the light produced by a light source into an optical system which is positioned in the light path downstream from the light source and whose area and acceptance angle are limited—e.g., when the goal is to couple the light into optical fibers, the light tunnel of a projector, spotlights, and comparable systems.

This is due to the fact that the light source predetermines its etendue, which is the volume covered within the phase space by the emitted radiation. At the same time, it is immediately clear, based on Liouville's theorem, that an entropy equation must apply to the etendue, and thus it is impossible to reduce the volume of the light bundle emitted into the phase space. In a paraxial approximation, the etendue is even a Lagrange invariant, and thus a constant.

The goal of an optical illuminating system is to modify the light emitted by a source, and therewith to modify its etendue, in such a way that an object is illuminated in a desired manner. From the etendue's conservation a deduction can be made on how much light from the source is usable or how large, at a maximum, a source can be for all of its light to be employed.

The resulting problems with respect to modern, high-performance LEDs can be easily demonstrated with the example of light coupled into a light guide that has a typical diameter of about 3.5 mm. For a LED with an area of 1 mm×1 mm, the radiating area could be increased by using a lens system which provided an image of the LED chip extended into infinity. By adjusting the angular distribution to the numerical aperture of the light guide it was thus possible, almost without loss, to so reduce the angle of radiation that a complete coupling of light into the light guide was permitted.

In contrast, when the LED has an edge length of 3 mm×3 mm, the diagonal length of the LED chip is 4.24 mm, with the result that the corners of the LED chip can no longer be mapped or copied onto the light guide. Conservation of the etendue dictates, in particular, that a reduction in the area of the emitted light must be accompanied by a widening of the angular distribution. Thus, in the attempt to achieve a better utilization of the LED area, the already existing portion of the emitted light which does not meet the acceptance requirement for the light guide became greater, so that the yield provided by coupling was not increased. Considerable losses in the usable output are the outcome.

From U.S. 2007018175 there is known a LED chip which is positioned on a base and has a housing that is provided with a partially metalized dome in order to reflect from the surface of the LED chip those light rays which are emitted by the LED at angles which do not fall into the acceptance area of a downstream light guide. At best, this procedure leads to a slight increase in the usable light yield of the LED chip.

The goal of the invention, therefore, is to provide an LED arrangement and a process for operating a LED arrangement, which provide an improved light yield when light is coupled into an optical system.

This goal is achieved by a LED arrangement with the features of claim 1 and by a process for operating a LED arrangement with the features of claim 7.

The LED arrangement according to the invention has at least one base, a LED chip positioned on the base, and a reflector which reflects a portion of the light emitted by the LED chip during operation of the LED arrangement. It is essential to the invention that the LED arrangement also has a luminescence-conversion layer, onto which is guided a portion of the light reflected by the reflector.

The invention is based on the knowledge that a significant improvement can be achieved in the light yield for light that is coupled into a downstream optical system (whose acceptance requirements are consequently fulfilled) if the light that is provided by the LED chip and that does not fulfill the acceptance requirements is used as an energy supply for a secondary light source. This occurs specifically in a luminescence-conversion layer in which the primary light of the LED chip that is reflected onto the layer is absorbed and a photon with a different and greater wavelength is then emitted. At the same time, the long-wave area of the light spectrum fed into the optical system is consequently intensified, and this causes the color temperature to drop and allows the light to appear warmer.

It is essential to the intended functioning of the LED arrangement that the luminescence-conversion layer is positioned on the LED chip and that the reflector is so designed that it copies an image of the LED chip onto the LED chip. A precondition for this is that the spatial extension of the LED chip and that of reflector are adjusted one to the other. In particular, this condition is not sufficiently fulfilled for basically spherical or parabolic reflectors if the diameter, or spatial extension, of the LED chip is not smaller by a factor of >3, and particularly >7, than the diameter, or spatial extension, of the reflector.

It has proven to be the case that a design where the shape of the reflector is that of the surface segment of a sphere leads to a good mapping of the LED chip onto itself when the LED chip has an spatial extension (as understood as the greatest distance between two of the chip edges) that is smaller by a factor of 5 than the diameter of the sphere, while very good results are achieved for a factor of 7 and excellent results are achieved for a factor of 10.

Positioning the luminescence-conversion layer, i.e., the secondary light source, on the LED chip ensures that light that is produced by the secondary light source and that fulfills the acceptance requirement of the optical system can be coupled into the optical system with the same coupling lens system that is used for the coupled portion of the primary light emitted by the LED chip.

A particularly simple reflector design is provided by a curved mirror. Moreover, this design allows the collection or focusing of primary light onto the luminescence-conversion layer or secondary light source.

In another advantageous variant the reflector can be so adjusted that it is possible to influence the mapping of the image of the LED chip onto the LED chip. It has proven to be the case that this kind of adjustment is essential for achieving an optimal performance. Multifarious means for the adjustment of optical elements are known to the specialist, and their enumeration here is unnecessary.

In an alternative embodiment of the invention the LED arrangement has a lens with which an image of the LED is extended into infinity and the reflector is a flat mirror, which (viewed outward from the LED chip) is positioned behind the lens and which maps back a portion of the light onto the LED chip. Particularly in applications where adjustment of the illuminating aperture is already provided, e.g., by means of a diaphragm, this embodiment allows the light yield to be effectively increased through use of a mirror-coated diaphragm.

Another particularly preferred embodiment of the invention provides that the reflector is movably positioned on the LED arrangement, specifically in such a way that the quantity of light reflected onto the luminescence-conversion layer can be varied. This embodiment confers a specific advantage in that the color temperature of the LED arrangement is adjustable. The user can thus select the color impression conveyed by the light emitted by the LED arrangement. This is of practical use, e.g., in medical applications. For example, it has proven to be the case that in endoscopies performed by physicians in the evaluation of inflammations a warm color tone is perceived to be more natural, while a colder color tone is preferred in differentiating blood vessels and tissue structures.

This is significant, on the one hand, because the manufacture of LEDs with a firmly defined color temperature is subject to a large degree of variation, and the purchase of a LED with a given color temperature will currently provide the user with only a LED whose color temperature lies somewhere within a relatively large range, the so-called bin. When another LED from the same bin is employed, a noticeably different color impression may arise.

On the other hand, it must be kept in mind that the last-named embodiment opens up the possibility of adjusting the color temperature without losses in efficiency. Usually a change in the color temperature is always accompanied by a lower photon yield. By way of contrast, in the design according to the invention, with its movable reflector, light that cannot be coupled into the optical system—because it does not fulfill the latter's acceptance requirements and is thus unavailable for the application—is used to make available the additional “warmer” color components.

The process according to the invention for operating a LED arrangement has at least these steps: producing light by means of the LED chip; reflecting a portion of the light produced by the LED chip; and coupling the light into an optical system that has an acceptance requirement. Here only the light that fulfills the acceptance requirement is coupled into the optical system. It is essential to the invention that the light is reflected onto a secondary light source which can be operated with reflected light, specifically onto a luminescence-conversion layer.

In a particularly advantageous variant of the process, there is added an adjustment step, whose purpose is to optimize the mapping of the image of the LED chip onto the LED chip. This step can occur in a test operation before the actual use of the LED chip, and particularly during the process in which LED arrangement is manufactured. However, this requires that the LED does not emit light during the process.

The invention will next be described in greater detail on the basis of the drawings. Shown are:

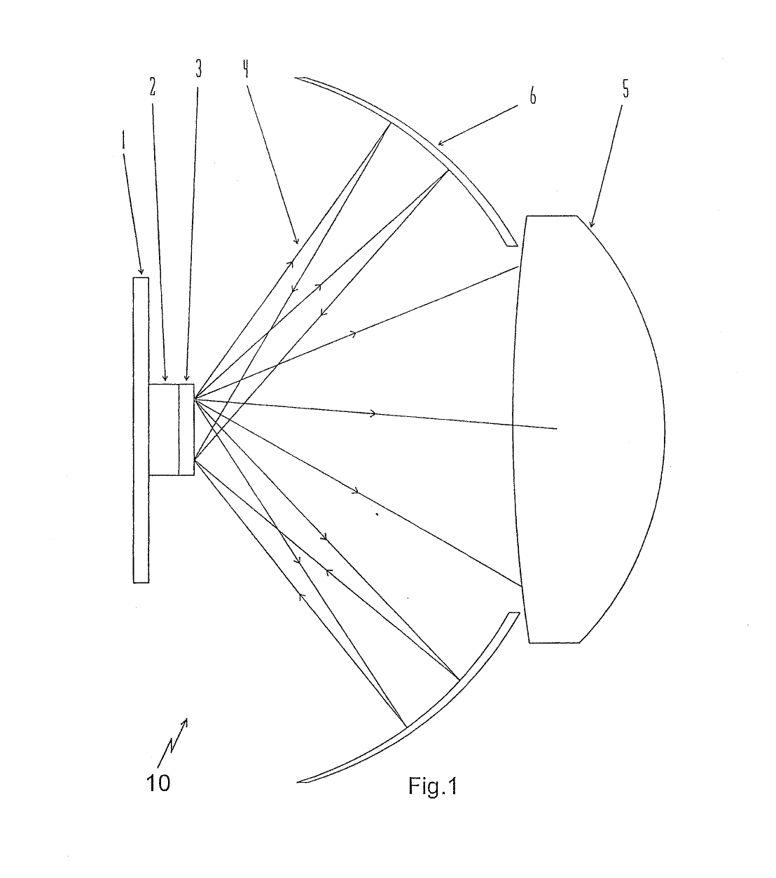

FIG. 1: sketch of a LED arrangement according to a first exemplary embodiment of the invention

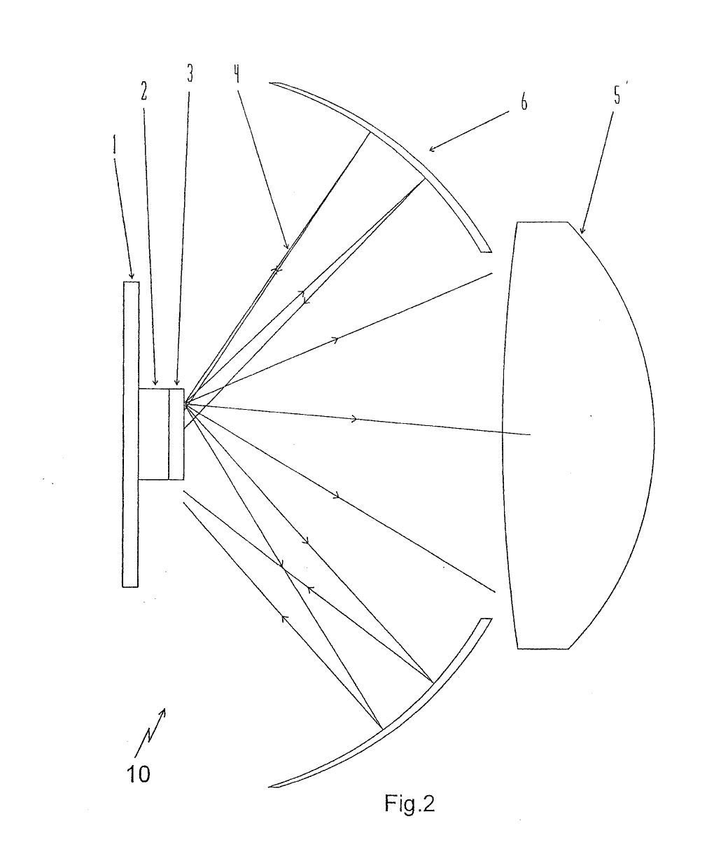

FIG. 2: sketch of the LED arrangement of FIG. 1, with the reflectors in shifted positions

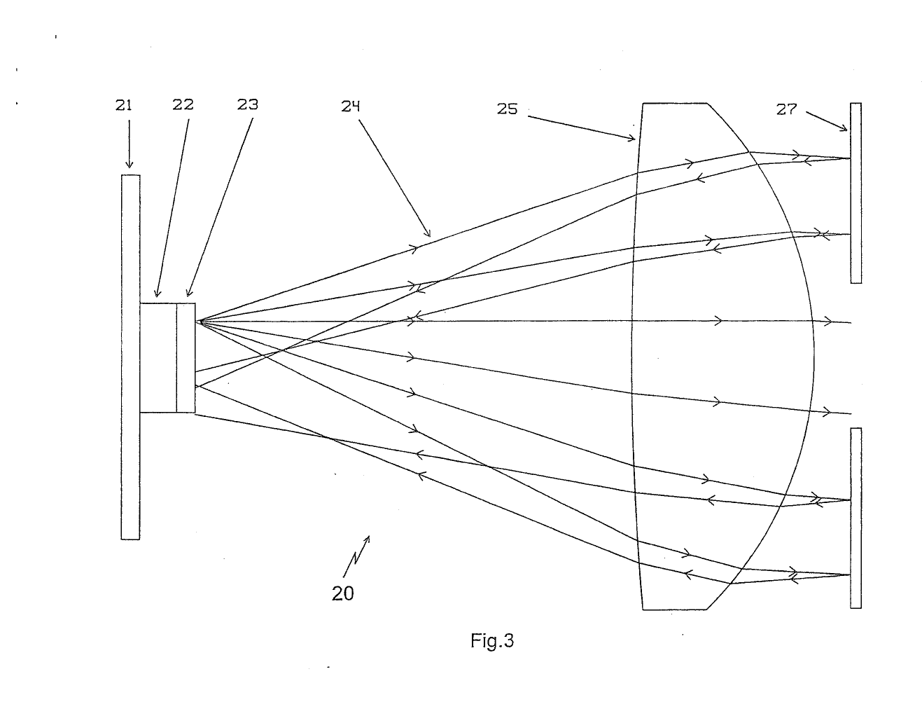

FIG. 3: sketch of a LED arrangement according to a second exemplary embodiment of the invention.

In each of the figures, identical reference numerals are used for the same components of the exemplary embodiments.

FIG. 1 shows a LED arrangement 10 according to an initial exemplary embodiment of the invention. Visible is a base 1, on which a LED chip 2 is positioned. The surface of this LED chip 2 has a secondary light source, which can be activated by light emitted by the LED chip 2 and which takes the form of a luminescence-conversion layer 3, whose thickness is exaggerated in the drawing for the sake of clarity. During its operation, the LED chip 2 emits light, a portion of which passes through the luminescence-conversion layer 3 and another portion of which activates the luminescence-conversion layer 3 after being absorbed in the latter so as to emit light with a greater wavelength. Both types of light spread out into space in the form of light rays 4. A portion of these light rays 4 strikes a first lens 5, where they are treated so as to be coupled into a downstream optical system, which is not depicted. Those light rays 4 that do not meet the acceptance requirements of this lens 5 will strike reflectors 6, which are movably positioned in the direction of motion between the base 1 and the lens 5 and which take the form of curved mirrors. These mirrors reflect the light rays 4 onto the secondary light source formed by the luminescence-conversion layer 3. There the light rays 4 are at least partially absorbed and excite the luminescence-conversion layer 3 to radiate secondary light, i.e., more light rays 4 which partially meet the acceptance requirement of lens 5. Thus, with a modified spectral distribution of light, it is possible to deliver an overall larger portion of light to the optical system and thus to more efficiently utilize the LED arrangement.

FIG. 2 shows the same embodiment of the invention as FIG. 1, the only difference consisting in the fact that in FIG. 2 the movably positioned reflectors 6 are positioned closer to the LED chip. As evident in FIG. 2, the result is that a few of the reflected light rays 4 do not strike the luminescence-conversion layer 4, and thus a less pronounced increase in efficiency is achieved, but one with a different spectral distribution of the light fed into the optical system. This illustrates the fact that the movable feature of the reflectors 6 provides an adjustable spectral distribution, in correspondence to the adjustable color temperature.

FIG. 3 depicts a LED arrangement 20 in accordance with a second embodiment. As in FIG. 1, a base 21 can be identified, along with LED chip 22, which has a luminescence-conversion layer 23 on its surface. Upon operation, the LED chip 22 is radiates light that in part passes through the luminescence-conversion layer and in part excites the luminescence-conversion layer 23, after the light has been absorbed, to radiate light of a different wavelength. Both types of light propagate into space as light rays 24. A portion of the light rays 24 strike a first lens 25, which prepares it for coupling into a downstream optical systems that is not depicted.

Here, in contrast to the embodiment shown in FIGS. 1 and 2, the usable light rays are concentrated in the vicinity of the optical axis (not shown) through the use of an aperture with a flat-mirror as a reflector 27. The light rays 24 reflected by the reflector 27 are mapped by the first lens 25 onto the luminescence-conversion layer 23. There these light rays 24 are at least partly absorbed and stimulate the luminescence-conversion layer 23 to radiate secondary light, i.e., more light rays 24 which at least partly fulfill the acceptance requirement of the first lens 25 and additionally strike the penetrable area of the flat-mirrored aperture and are thus usable for the downstream optical system. It this way it is possible to introduce more light into the optical system in axially proximate fashion and thus to again use the LED arrangement more efficiently.

Reference is made to the fact that all the depicted figures clearly show that the LED chips 2, 22 each have an appreciably smaller spatial extension than the reflector. This fact is an essential condition for mapping an image of the LED chip 2, 22 onto itself.

### List of Reference Numerals

1, 21 Base

2, 22 LED Chip

3, 23 Luminescence-Conversion Layer

4, 24 Light Rays

5, 25 Lens

6, 27 Reflector

10, 20 LED Arrangement

1. LED arrangement (10, 20), with a base (1, 21), a LED chip (2, 22) positioned on the base (1, 21), and a reflector (6, 27) which reflects a portion of the light emitted from the LED chip (2, 22) upon operation of the LED arrangement (10, 20),
wherein
the LED arrangement (10, 20) has a luminescence-conversion layer (3, 23) onto which at least a portion of the light reflected by the reflector (6, 27) is guided, while the luminescence-conversion layer (3, 23) is positioned on the LED chip (2, 22) and the reflector (6, 27) is so designed that the reflector (6, 27) maps an image of the LED chip (2, 22) onto the LED chip (2, 22).

2. LED arrangement (10, 20) according to claim 2,
wherein
the reflector (6, 27) is a curved mirror.

3. LED arrangement (10, 20) according to claim 1,
wherein
the reflector (6, 27) can be adjusted so as to influence the mapping of the image of the LED chip (2, 22) onto the LED chip (2, 22).

4. LED arrangement (10, 20) according to claim 2,
wherein
the LED arrangement (10, 20) has a lens (5, 25) which furnishes an image of the LED chip (2, 22) extending into infinite distance and the reflector (6, 27) is a flat mirror, which is positioned behind the lens when viewed outward from the LED chip (2, 22) and which maps back a portion of the light onto the LED chip (2, 22).

5. LED arrangement (10, 20) according to claim 1,
wherein
the reflector (6, 27) is movably positioned on the LED arrangement (10, 20) and in such a way that the quantity of the light reflected onto the luminescence-conversion layer (3, 23) can be varied.

6. Process for operating a LED arrangement (10, 20) having at least the following steps:
producing light by means of a LED chip (2, 22)
reflecting a portion of the light produced by the LED chip (2, 22), and
coupling the light into an optical system which has an acceptance requirement, such that only light that fulfills the acceptance requirement can be coupled into the optical system,
wherein
the light is reflected onto a luminescence-conversion layer (3, 23) in such a way that the reflector (6, 27) maps an image of the LED chip (2, 22) onto the LED chip (2, 22).

7. Process according to claim 6
wherein
an adjustment step is provided, by means of which the mapping of the image of the LED chip (2, 22) onto the LED chip (2, 22) can be optimized.
